(19) United States
(12) Patent Application Publication
(10) Pub. No.: US 2022/0134594 A1
(43) Pub. Date: May 5, 2022

(54) BAMBOO TABLEWARE PROCESSING METHOD AND APPARATUS

(71) Applicant: HUNAN YINSUN BAMBOO INDUSTRY CO., LTD., Shaoyang, Hunan (CN)

(72) Inventor: Zhengwen LI, Shaoyang, Hunan (CN)

(21) Appl. No.: 17/433,991

(22) PCT Filed: Feb. 26, 2020
(86) PCT No.: PCT/CN2020/076707

§ 371 Date: Aug. 25, 2021

(30) Foreign Application Priority Data
Feb. 27, 2019 (CN) 201910144382.8
Feb. 27, 2019 (CN) 201920245005.9
Feb. 27, 2019 (CN) 201920245133.3
Feb. 26, 2020 (CN) 202010117909.0

(51) Int. Cl. B27C 5/06; B27J 1/00; B27M 3/24; B27G 3/00

(52) U.S. Cl. CPC B27C 5/06; B27G 3/00; B27M 3/24; B27J 1/00

(57) ABSTRACT

A bamboo tableware processing method, comprising the following steps: S1, using a clamping member (4) to clamp a plurality of bamboo chips; S2, controlling a milling cutter (2) to rotate; and S3, moving the clamping member and/or the milling cutter to cut the plurality of bamboo chips by means of the milling cutter. Also provided is a bamboo tableware processing apparatus. According to the processing method, a plurality of bamboo chips are processed simultaneously, the processing efficiency is improved, and the quality of the product is improved. Moreover, a plurality of bamboo chips are subjected to high-speed milling and cutting at one time, burrs may not be generated at edges of the bamboo chips, and the step of polishing for burr removing is omitted.

### CROSS-REFERENCE

Priority is claimed from PCT/CN2020/076707 filed on Feb. 26, 2020 which claims the priority of China Patent Application No. 201910144382.8 filed on Feb. 27, 2019, China Patent Application No. 201920245133.3 filed on Feb. 27, 2019, China Patent Application No. 201920245005.9 filed on Feb. 27, 2019, China Patent Application No. 202010117909.0 filed on Feb. 26, 2020, which are hereby incorporated by reference.

### DESCRIPTION OF RELATED ART

The present invention relates to the field of tableware processing, in particular, to a method and apparatus for processing bamboo tableware.

At present, the catering industry generally uses disposable tableware, in China, people usually use disposable bamboo chopsticks, bamboo is an environmentally friendly material and will not pollute the environment; however, in foreign countries, the disposable tableware used by people is mainly plastic knife, fork and spoon, because plastics is difficult to break down and easily pollute the environment, it is called “white pollution”; at the same time, as the “plastic ban” is gradually introduced in some countries and regions, the market of the plastic tableware is in a downturn, and more businesses have begun to use disposable bamboo tableware.

Because the shape and structure of knife, fork and spoon are completely different from the chopsticks, the process of processing knife, fork and spoon is also different from the chopsticks in the bamboo tableware processing industry. The current process of processing bamboo cutlery is as follows: the raw bamboo is made into bamboo strips, and the bamboo strips are made into rectangular bamboo chips, and then processed into bamboo tableware-shaped bamboo chips, finally, the fork and spoon-shaped bamboo chips are heat-pressed to form usable spoons and forks, and cut the blades of the knife-shaped bamboo chips diagonally to form the final bamboo knives.

In the process of processing rectangular bamboo chips into the shape of bamboo tableware, most prior art is stamping to process, and some are processed by milling cutter. For example, the application number: CN201610059496. 9 “The apparatus and producing process for industrial production of bamboo knife and spoon with moso bamboo chips”, which comprises a bamboo chip cutting machine, a bamboo knife, fork and spoon processing and polishing integrated machine, and a mold of one-time processing spoon with bamboo chip, among them, the bamboo knife, fork and spoon processing and polishing integrated machine can only process one rectangular bamboo chip into one bamboo tableware-shaped bamboo chip at one time, the processing efficiency is low, and the edge of the bamboo chip is prone to burrs after being cut by the milling cutter, which needs to be polished, there is a certain gap in the size of single product after polishing.

### SUMMARY

The purpose of the present invention is to overcome the above mentioned shortcomings of the prior art and provide a bamboo tableware processing method and apparatus for processing a plurality of bamboo chips without polishing at one time.

The technical solution of the present invention is as follow:

The present invention is bamboo tableware processing method and apparatus and comprising the following steps:

S1, using a clamping member (4) to clamp a plurality of bamboo chips;

S2, controlling a milling cutter (2) to rotate;

S3, moving the clamping member and/or the milling cutter to cut the plurality of bamboo chips by means of the milling cutter.

The above mentioned solution has the following advantages: a plurality of bamboo chips are clamped by the clamping member, when slowly passing the high-speed rotating milling cutter, the bamboo chips are cut by the milling cutter a little bit, and when one bamboo chip is processed by the milling cutter, due to the force, burrs will appear on the bamboo chips, but after a plurality of bamboo chips are clamped at the same time, the plurality of bamboo chips is restricted to each other due to the force, which is equivalent to forming a rectangular overall structure instead of one bamboo chip, therefore, no burrs will appear when processing a plurality of bamboo chips, which greatly saves the time for polishing and deburring; in this method, the clamping member can be moved and the milling cutter can be fixed; it can also be the milling cutter moved and the clamping part fixed; it can also be that the clamping member and the milling cutter move at the same time; preferably, the clamping member is moved and the milling cutter is fixed, because the milling cutter does not move, it is safer during processing.

Further, in S3, the cutting movement route of the bamboo chips is parallel to one of the tangent lines of the circle formed by the rotation of the milling cutter, and the distance from the tangent line remains unchanged. A plurality of bamboo chips are tangent to the outer circle formed by the rotation of the milling cutter, the edge of the bamboo chips is cut by the milling cutter, after cutting, the bamboo chips becomes tableware-shaped bamboo chips; when the milling cutter rotates, there will be countless tangent lines, the movement route of bamboo chips being parallel to any one of the tangent lines is to ensure that the bamboo chips can be moved along a straight line under the premise of cutting the bamboo chips by the milling cutter.

Further, the number of the plurality of bamboo chips is 20 to 200. Preferably, the number of the plurality of bamboo chips is 40 to 100; further preferably, the number of the plurality of bamboo chips is 60 to 80.

If there are less than 20 at one time, the production efficiency will be seriously affected; if more than 200, the clamping member can't hold the bamboo chips well, and the bamboo chips are likely to be scattered during processing; preferably, when processing 20 to 40 at one time, the processing efficiency is still relatively low; when 100 to 200, the bamboo chips may still be scattered during the processing; when the number of the bamboo chips is 60 to 80, the processing efficiency is appropriate, also there will be no scattered bamboo chips at the same time.

Further, in S1, it specifically comprising: immediately using a clamping member to clamp a plurality of bamboo chips; or placing defective replacement blocks between the plurality bamboo chips and the clamping members, and clamping a plurality of bamboo chips and defective replacement blocks by the clamping member.

After many times of processing, it is found that some of the bamboo chips are prone to be unqualified during processing, these unqualified bamboo chips are often the bamboo chips located at both ends, that is the bamboo chips close to the clamping members, this situation may be caused by the force and other reasons; therefore, defective replacement blocks are arranged at both ends, so that unqualified situation occurs on the defective replacement blocks, thereby improving the overall pass rate. The defective replacement blocks also need to be cut by the milling cutter, and the shape will be the same as the bamboo tableware, the material of the defective replacement blocks is preferably bamboo, wood or plastic, etc., such materials will not damage the milling cutter.

Further, in S2, during the rotation of the milling cutter, the position and angle of the milling cutter are selectively adjusted.

Further, adjusting the position of the milling cutter does not include the feeding direction of the multiple bamboo chips.

Further, the bamboo chips are vertically and flatly arranged between the clamping members, and the plurality of bamboo chips are cut along a straight line by milling cutters on both sides, and the plurality of bamboo chips are sequentially cut and processed into bamboo tableware-shaped at one time.

Further, it specifically comprises the following steps:

S101: setting the milling cutter inside of the cover of the bamboo shavings collecting apparatus (6), and the cutting part of the milling cutter extends from the cover;

S201: placing the plurality of bamboo chips between the clamping members (4) and clamping; or place defective replacement blocks on both ends of the plurality of bamboo chips, and clamp bamboo chips and defective replacement blocks by the clamping members (4);

S301: if the plurality of bamboo chips are not flat, performing a flattening step to ensure that the bamboo chips are flat; after flattening, the plurality of bamboo chips are further compressed;

S401: control the clamping member (4) or the milling cutter (2) to move slowly, so that the plurality of bamboo chips are cut along a straight line by the milling cutter, when cutting, one side of the plurality of bamboo chips is cut firstly, after cutting, then performing the cutting work on the other side; or both sides of the plurality of bamboo chips are cut at the same time to process at one time;

S501: after cut by the milling cutter, the bamboo chips are processed into bamboo tableware-shaped bamboo chips; after the clamping member is moved out of the working range of the milling cutter, controlling the clamping chips to loosen the bamboo chips.

The present invention is bamboo tableware processing apparatus comprising:

Processing platform;

Milling cutter: the blade profile of the milling cutter matches at least one side profile of the bamboo tableware;

Motor: used to control the rotation of the milling cutter;

Clamping member: used to clamp a plurality of bamboo chips at one time, and at least one of the clamping member and the milling cutter is movably arranged on the processing platform.

Further, the clamping member comprises two oppositely arranged clamping chips, at least one of the clamping chips can be movably arranged to reduce or increase the distance between the two clamping chips.

Among them, the clamping member must have two clamping chips to achieve the purpose of clamping the bamboo chip; the clamping chips are moved to reduce or increase the distance to facilitate loading and unloading, and can better clamp the bamboo chips. One of the clamping chips can be moved, or both can be moved, usually only one clamping chip moving is required; moving reduced or increasing the distance of movement means that the clamping chips only need to be moved in a straight line, and the specific movement method can be manual, electric, pneumatic, etc., preferably using air cylinder to control.

Further, the profile of the clamping chips are the same as the profile of the corresponding bamboo tableware.

Further, a milling cutter adjusting apparatus is arranged on the processing platform, and the milling cutter is arranged on the milling cutter adjusting apparatus; or the milling cutter adjusting apparatus comprises a first adjusting part and a second adjusting part, the first adjusting part is fixedly or movably connected to the processing platform, the second adjusting part can move along the first adjusting part, and the second adjusting part is fixedly connected, slidably connected, rotationally connected to the milling cutter.

Further, the bamboo tableware is spoon, knife or fork;

When the bamboo tableware is spoon, the profile of the milling cutter matches one side profile of the spoon; the side profile of the spoon comprises the straight line of the spoon handle, the circular arc of the connection between the spoon handle and the spoon head, and the half circular arc of the spoon head; the profile of the milling cutter comprising: a straight line part corresponding to the length of the spoon handle, a circular arc part corresponding to the angle and radius of the connection, and a half circular part corresponding to the angle and radius of the spoon head;

When the bamboo tableware is knife, the profile of the milling cutter matches one side profile of the knife; the knife comprises a first side and a second side, and the first side of the knife comprises the straight line of the knife handle and the serrated arc of the knife head, the second side of the knife comprises the straight line of the knife back; there are two types of milling cutters for processing the knife, and the profile of the milling cutter for processing the first side of the knife comprises a knife handle straight line part corresponding to the straight length of the knife handle, and a serrated arc part corresponding to the knife head; the profile of the milling cutter for processing the second side of the knife comprises a knife back straight line part corresponding to the straight length of the knife back;

When the bamboo tableware is fork, the profile of the milling cutter matches one side profile of the fork; the side profile of the fork includes the straight line of the handle, the arc of the connection between the handle and the head, and the straight line of the head; the profile of the milling cutter comprises a straight line part corresponding to the straight line of the fork handle, an arc part corresponding to the arc of the connection, and a straight line part corresponding to the fork head.

Further, the milling cutter is sleeved with a bamboo shavings collecting apparatus; the bamboo shavings collecting apparatus comprises sequentially connected a knife cover, a pipeline, a fan, and a collecting box, and the knife cover is arranged on the milling cutter; a cutting port is arranged on one side of the knife cover.

Further, a shaft hole is arranged on the knife cover, and the drive shaft connected to the milling cutter and the motor passes through the shaft hole.

Further, the clamping member is movably arranged on the processing platform, and the clamping member moves along one of the tangent lines of the circle formed by the rotation of the milling cutter.

Further, at least one side of the clamping member is arranged with a flattening plate for flattening the bamboo chips, and the flattening plate is arranged on the processing platform through an actuator.

Further, there are multiple groups of milling cutters, which are respectively located on the side of the bamboo chips, and work at the same time to complete processing at one time. And the setting of milling cutters is misaligned.

The beneficial effects of the present invention: subverting the traditional bamboo tableware processing method, on one hand, it can process a plurality of bamboo chips at one time, greatly improving the processing efficiency; it improves the product quality at the same time, and it can high-speed mill and cut a plurality of bamboo chips at one time, burrs may not be generated at edges of the bamboo chips, and the step of polishing for burr removing is omitted; on the other hand, the bamboo shavings can be collected in time during the processing process to prevent the bamboo shavings from splashing and affecting the work process. The structure of the apparatus is simple, and the design is scientific and reasonable.

### BRIEF DESCRIPTION OF THE DRAWINGS

In order to explain the technical solution more clearly in the embodiments of the present invention, the following will briefly introduce the drawings used in the description of the embodiments, obviously, the drawings in the following description are only showing the embodiments of the present invention, ordinary technicians in this field can obtain other drawings based on these drawings without creative efforts.

FIG. 1 is the simplified schematic diagram of the present invention;

FIG. 2 is the schematic diagram of three-dimensional structure of the present invention;

FIG. 3 is the top view of the structure shown FIG. 2;

FIG. 4 is the schematic diagram of the clamping member;

FIG. 5 is the schematic diagram of three-dimensional structure of the milling cutter adjusting apparatus;

FIG. 6 is the specific structure schematic diagram of the milling cutter adjusting apparatus;

FIG. 7 is the schematic diagram of the bamboo shavings collecting apparatus;

FIG. 8 is the schematic diagram of the pipeline structure of the bamboo shavings collecting apparatus;

FIG. 9 is the front view of the milling cutter rotating for the processing spoon;

FIG. 10 is the front view of the milling cutter rotating for the processing knife;

FIG. 11 is the front view of the milling cutter rotating for the processing fork;

FIG. 12 is the schematic diagram of the bamboo chips of spoon, fork and knife;

In figures: 1 is a processing platform, 2 is a milling cutter, 3 is a motor, 4 is a clamping member, 41 is a clamping chip, 42 is a clamping cylinder, 5 is a milling cutter adjusting apparatus, 51 is an intermediate plate, 511 is a rotating plate, 512 is a fixed plate, 513 is an adjusting screw, 52 is a vertical plate, 53 is a moving cylinder, 6 is a bamboo shavings collecting apparatus, 61 is a knife cover, 611 is a cutting port, 612 is a shaft hole, 62 a pipeline, 7 is a flattening plate, 71 is a flattening cylinder, 8 is a trackless cylinder.

### DETAILED DESCRIPTION OF SAMPLE EMBODIMENTS

In order to make the technical problems, technical solutions and beneficial effects solved by the present invention more clear, the following further describes the present invention in detail with reference to the accompanying drawings and embodiments. It should be understood that the specific embodiments described herein are only used to explain the present invention, and are not intended to limit the present invention.

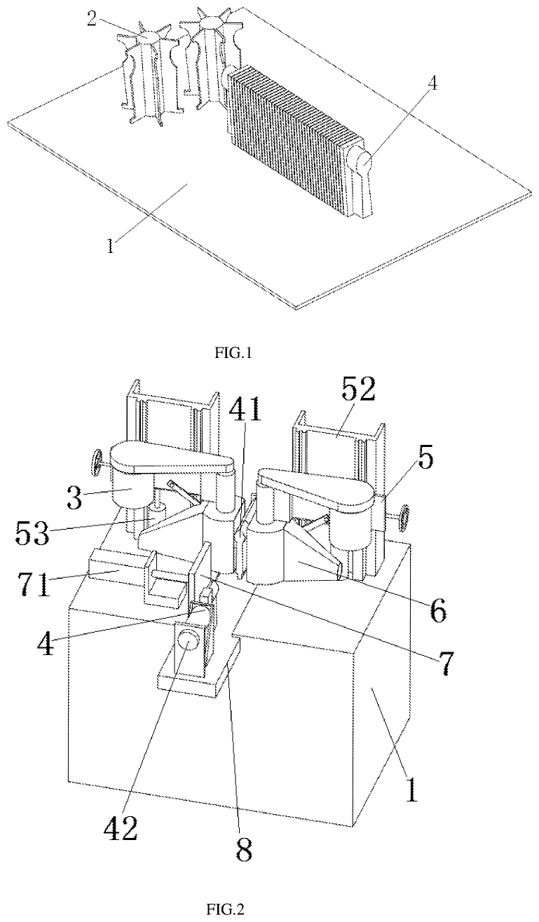

As shown in FIG. 1 to 3, a bamboo tableware processing apparatus, comprising a processing platform 1, a milling cutter 2, a motor 3 that controls the rotation of the milling cutter 2, and clamping members 4 for clamping a plurality of bamboo chips. The profile when the milling cutter 2 rotates matches at least one side profile of the bamboo tableware.

In this embodiment, at least one of the clamping member 4 and the milling cutter 2 is movably arranged on the processing platform 1 to ensure that there is feed movement between the bamboo chips and the milling cutter 2, in this embodiment, the clamping member is preferably movably arranged. For example: the processing platform 1 is arranged with at least one electric sliding rail, and the clamping member 4 is arranged on the sliding block of the electric sliding rail; or the processing platform 1 is arranged with a trackless cylinder 8 and the clamping member 4 is connected to a trackless cylinder 8.The clamping member 4 is driven by the electric sliding rail or the trackless cylinder 8 to move along the tangential direction formed by the rotation of the milling cutter 2. The bamboo chips in this embodiment are rectangular bamboo chips.

As shown in FIG. 4, the clamping member 4 comprises two oppositely arranged clamping chips 41 and a mounting base, one of the clamping chips is movable by clamping cylinder 42, and at least one of the clamping chips is actively arranged, preferably, one clamping chip is actively arranged, and the movement of the clamping chips is used to reduce or increase the distance between the two clamping chips 41. The clamping cylinder 42 is fixed on the mounting base, the mounting base is arranged on the processing platform 1, and the clamping chips are connected to the piston rod of the clamping cylinder 42. In this embodiment, the interval between the two clamping chips 41 is preferably 15 cm to 30 cm; the interval determines the number of clamped bamboo chips; if the interval is too small, the number of clamped bamboo chips is smaller, and the processing efficiency is low, if it is too large, the bamboo chips are prone to be scattered and reduce the success rate. The profile of the clamping chips 41 is the same as the bamboo tableware.

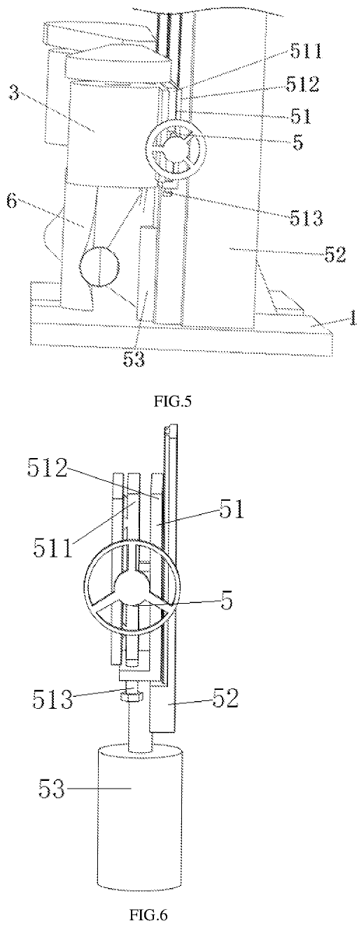

As shown in FIG. 5 and 6, the processing platform 1 is arranged with a milling cutter adjusting apparatus 5, and the milling cutter 2 is arranged on milling cutter adjusting apparatus 5, the milling cutter adjusting apparatus 5 comprises a slidably connected intermediate plate 51 and a vertical plate 52, the milling cutter 2 is slidably connected with the intermediate plate 51, and the vertical plate 52 is fixedly arranged on the processing platform 1. The intermediate plate 51 comprises a rotating plate 511 and a fixed plate 512, the rotating plate 511 is rotationally connected with the fixed plate 512, the milling cutter 2 is connected with the rotating plate 511, and the fixed plate 512 is slidably connected with the vertical plate 52. In this embodiment, the fixed plate 512 is L-shaped, the rotating plate 511 is arranged within the right angle of the fixed plate 512, and there is a rotatable gap between the bottom of the rotating plate 511 and the fixed plate 512. The bottom of the fixed plate 512 is arranged with an adjusting screw 513, and the end of the adjusting screw 513 passes through the rotatable gap to contact the rotating plate 511. By rotating the adjusting screw 513, the adjusting screw moves relatively to the fixed plate 512, and the rotating plate 511 receives the force of the adjusting screw to realize rotating. The sliding connection between the intermediate plate 51 and the vertical plate 52 is controlled by moving cylinder 53, the moving cylinder 53 is arranged on the processing platform 1, the end of the piston rod of the moving cylinder 53 is connected to the intermediate plate 51, when the piston rod of the moving cylinder 53 moves, driving the intermediate plate 51 to slide along the vertical plate 52. It is understandable that the sliding connection can also be other manual or automatic methods, as long as it is a linear movement, such as a screw mechanism, and the workpiece can be moved along a straight line by turning the handle.

Alternatively, the milling cutter adjusting apparatus 5 comprises a slidably connected intermediate plate 51 and a vertical plate 52, the milling cutter 2 is fixedly connected to the intermediate plate 51, and the vertical plate 52 is slidably arranged on the processing platform 1, which can also achieve the purpose of adjusting the milling cutter 2.

In this embodiment, the milling cutter adjusting apparatus 5 can adjust the two-dimensional position and angle of the milling cutter 2; when the milling cutter adjusting apparatus 5 is used, the milling cutter 2 is in a rotating state, and adjusting the two-dimensional position of the milling cutter 2 does not comprise the feeding direction of bamboo chips processing, for example, the feeding direction of the milling cutter 2 and the bamboo chips is arranged in front and back, then milling cutter adjusting apparatus 5 can adjust the milling cutter 2 to move up and down, and left and right, in this way, when the milling cutter is worn, the middle of the bamboo chips cannot be processed, the milling cutter can be adjusted in time, and it is convenient to replace and disassemble the milling cutter.

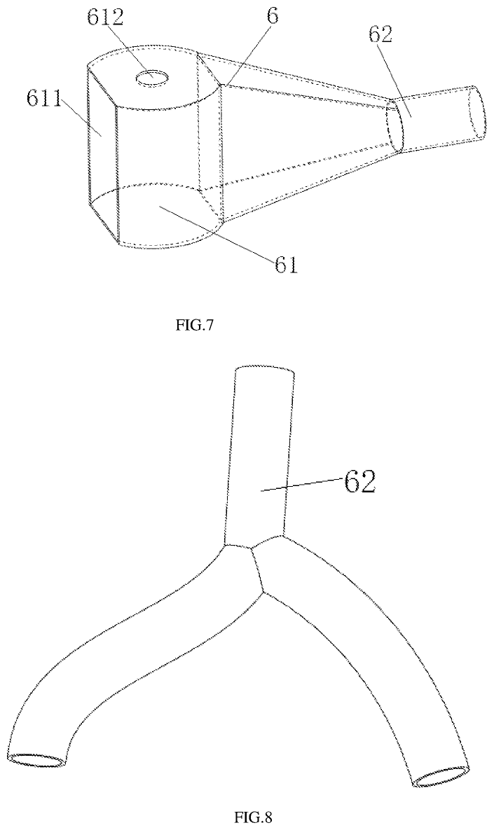

As shown in FIGS. 7 and 8, the milling cutter 2 is sleeved with a bamboo shavings collecting apparatus 6, which comprises sequentially connected a knife cover 61, a pipeline 62, a fan and a collecting box, and a knife cover 61 is arranged on the milling cutter 2, the knife cover 61 is a cylinder, the side wall of the knife cover 61 is provided with a cutting port 611, the cutter cover 61 is provided with a shaft hole 612, and the drive shaft connecting the milling cutter 2 and the motor 3 passes through the shaft hole 612, the bamboo shavings pass through the suction force generated by the fan inside of the knife cover 61 and reach the collecting box through the pipeline 62, the blade of the milling cutter 2 needs to be exposed out of the cutting port 611 for cutting.

The pipeline 62 in this embodiment can be a multi-pass pipeline, and the pipeline 62 can also be connected to multiple knife covers 61, only one fan and a collecting box are arranged at the end, which saves costs; the fan can use the existing axial flow fan; the fan and the collecting box are not shown in the figure, which are common knowledge in the art, in addition, in this embodiment, the milling cutter 2, the milling cutter adjusting apparatus 5, the motor 3, etc. are preferably two groups, so the multi-pass pipeline can be a common human-shaped pipeline, the pipeline is connected to two knife covers 61, and only one fan is connected at the end.

In this embodiment, the bamboo tableware is spoon, knife or fork.

As shown in FIG. 9, when the bamboo tableware is spoon, the profile of the milling cutter 2 matches one side profile of the spoon. The side profile of the spoon comprises the following three parts: the straight line of the spoon handle, the circle arc of the connection between the spoon handle and the spoon head, and the half circle arc of the spoon head; the profile of the milling cutter for processing the spoon comprises the following three parts: the straight line part corresponding to the length of the spoon handle, the circle arc part corresponding to the angle and radius of the connection, and the half circle arc part corresponding to the angle and radius of the spoon head.

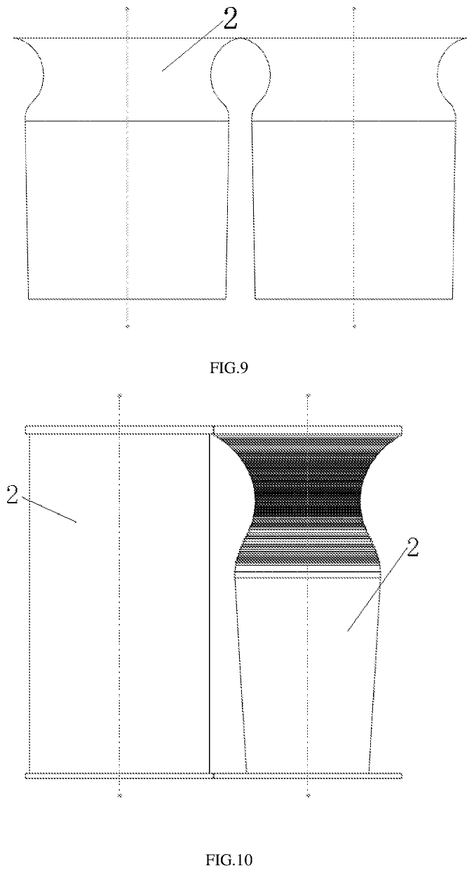

As shown in FIG. 10, when the bamboo tableware is knife, the profile of the milling cutter 2 matches one side profile of knife. The knife comprises a first side and a second side, the first side of the knife comprises the straight line of the handle and the serrated arc of the knife head; the second side of the knife comprises the straight line of the knife back. There are two types of milling cutters 2 for processing the knife, and the profile respectively matches the profile of the first side and the second side of the knife. The profile of the milling cutter processing the first side of the knife comprises the knife handle straight line part corresponding to the length of the knife handle straight line, and the serrated arc part corresponding to the knife head; the profile of the milling cutter for processing the second side of the knife comprises the knife back straight line part corresponding to the length of the knife back.

As shown in FIG. 11, when the bamboo tableware is fork, the profile of the milling cutter 2 matches one side profile of the fork. The side profile of the fork comprises the straight line of the handle, the double S-shaped arc of the connection between the handle and the head, and the straight line of the head; the profile of the milling cutter for processing the fork comprises the straight line part corresponding to the straight line of the fork handle, a double arc part corresponding to the double S-shaped arc of the connection, and a straight part corresponding to the straight line of the fork head.

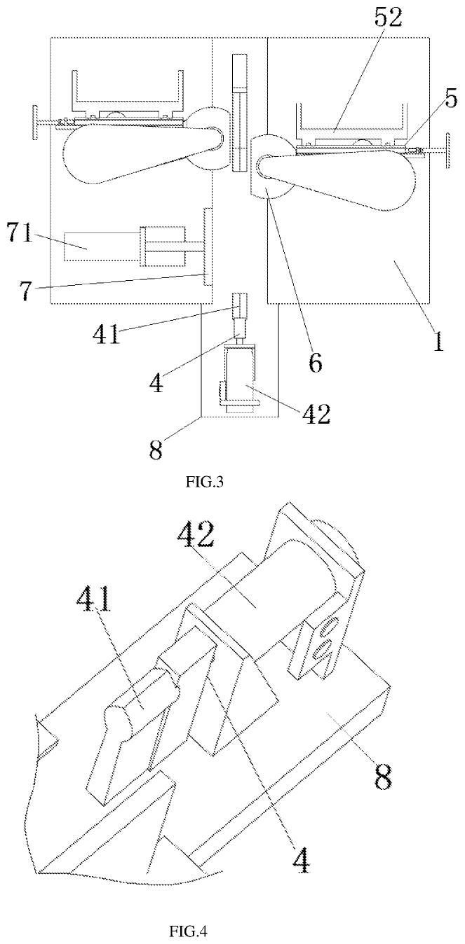

As shown in FIGS. 2 and 3, the milling cutter 2 is arranged inside of the knife cover 61 of the bamboo shavings collecting apparatus 6, preferably, the number of milling cutters 2 is two groups, which are located on both sides of the clamping member 4, two groups of milling cutters work at the same time to complete the processing at one time. The setting of the milling cutters is misaligned, the distance between the two milling cutters is preferably 1 cm to 6 cm, if the two milling cutters are in a horizontal line, the two milling cutters need to be tangent to ensure the complete profile of the bamboo chips, as shown in FIGS. 9 to 11, both ends of the milling cutters is tangent, if not tangent, the bamboo chips will be unqualified, if intersected, the milling cutter will be damaged; the misaligned settings are shown in FIG. 3, the bamboo chips will be successively processed by two groups of milling cutters, which can effectively avoid the tangential processing of the milling cutter, reduce the difficulty of adjusting the milling cutters, and have a low error tolerance rate; the distance of 1 cm to 6 cm ensures under the premise that the milling cutters is misaligned, the force on both sides of the bamboo chips is as even as possible, to reduce the scattering of the bamboo chips due to the uneven force on the left and right during processing; the distance of 1 cm to 6 cm is based on the size of the milling cutter and the clamping force of the clamp member, and depend on the number of bamboo chips, if the distance is too long, the failure rate of scattering during processing is higher.

In this embodiment, the milling cutter 2 uses down milling to process bamboo chips. Generally, milling cutter processing methods can be divided into down milling and up milling, when the rotating direction of the contact part of the milling cutter and the workpiece is the same as the feeding direction of the workpiece, that is, the component of the force of the milling cutter on the workpiece in the feeding direction, is the same as the feeding direction of the workpiece, it is called down milling, the advantage of down milling is that the surface quality of the workpiece is good and the wear of the milling cutter teeth is small.

As shown in FIG. 2 and 3, at least one side of the clamping member 4 is arranged with flattening plate 7 for flattening the bamboo chips, and the flattening plate 7 is arranged on the processing platform 1 through flattening cylinder 71; in this embodiment, the number of the flattening plate 7 is preferably one, and the rectangular bamboo chips need to be neatly arranged before processing, so that the plurality of bamboo chips are flat, and only one flattening plate can effectively flatten the bamboo chips. The reason why the actuator uses a cylinder is that cylinder is pneumatic apparatus, compared with other actuators, the cylinder has advantages of strong flexibility, compact structure, more stopping times, high precision, good adaptability to the working environment, and no oil pollution.

A preferred embodiment of the processing method of this embodiment comprises the following steps:

S101:the milling cutter 2 is arranged inside of the knife cover 61 of the bamboo shavings collecting apparatus 6, and the cutting part of the milling cutter extends from the cutting port 611 of the knife cover 61;

S102: starting the motor 3 and the fan, controlling the movement of a clamping chip by the clamping cylinder 42, placing a certain number (such as 70) of rectangular bamboo chips vertically, and arrange them in a row between the two clamping chips 41; placing defective replacement blocks on both ends of the 70 rectangular bamboo chips, clamping the bamboo chips and the defective replacement blocks by the clamping chips 41;

S103: If the 70 bamboo chips are not flat, controlling the flattening cylinder 71 to move the flattening plate 7 so that the flattening plate 7 is blocked on one side of the transverse position of the bamboo chips, and the other side of the bamboo chips is flattened by tapping with a tapping tool to ensure that the 70 bamboo chips are flat; after flattening, the distance between the clamping chips is further reduced to compress the bamboo chips;

S104: controlling the whole clamping member 4 to move slowly, and cut along a straight line by the milling cutter 2, and the straight line direction is parallel to one of the tangents of the circle formed by the rotation of the milling cutter; specifically, 70 bamboo chips move slowly between the milling cutters on both sides; the two sides of the bamboo chips are cut by two milling cutters successively, and the milling cutter is the processing milling cutter; the milling cutter adjusting process is mainly realized by the milling cutter adjusting apparatus 5, as shown in FIG. 5 and FIG. 6, rotating the handle can adjust the distance between the two milling cutters, the moving cylinder 53 adjusts the height of the milling cutter, rotating the adjusting screw 513 is used to adjust the inclination angle of the milling cutter; first roughly adjusting the position of the milling cutter, and then rotating the milling cutter, the clamping member 4 clamps the bamboo chips to feed, and be cut by the milling cutter, and adjusting according to the cut bamboo chips, if the middle of the bamboo chips is not processed, adjusting the distance between the two milling cutters, if one side is high and the other is low, adjusting the height of the two milling cutters, if a part is not processed, and the other part is processed too much, adjusting the inclination angle of the two milling cutters, in this cycle, cutting and adjusting milling cutters are repeated until the bamboo chips are processed to be qualified.

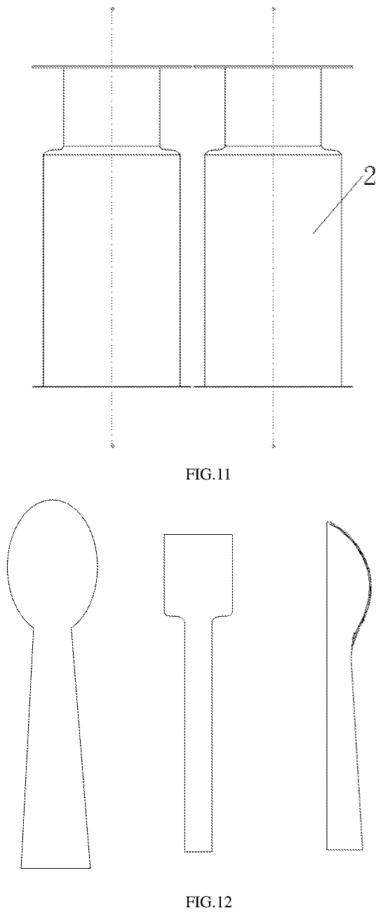

S105: After cutting by the milling cutter 2, the rectangular bamboo chips can be processed into bamboo tableware-shaped bamboo chips, as shown in FIG. 12;

S106: After the clamping member 4 moving out of the working range of the milling cutter 2, stopping the movement of the clamping chip 4, and control the clamping chip 41 to expand the distance and loosen the bamboo chips.

Although the embodiments of the present invention have been shown and described above, it can be understood that the above mentioned embodiments are exemplary and cannot be understood as limiting the present invention, technicians in the field can make changement, modifications, substitutions, and variations to the foregoing embodiments within the scope.

1. A bamboo tableware processing method, wherein comprising the following steps:
S1, using a clamping member (4) to clamp a plurality of bamboo chips;
S2, controlling a milling cutter (2) to rotate;
S3, moving the clamping member and/or the milling cutter to cut the plurality of bamboo chips by means of the milling cutter.

2. The bamboo tableware processing method according to claim 1, wherein in S3, the cutting movement route of the bamboo chips is parallel to one of the tangent lines of the circle formed by the rotation of the milling cutter, and the distance from the tangent line remains unchanged.

3. The bamboo tableware processing method according to claim 1, wherein the number of the plurality of bamboo chips is 20 to 200.

4. The bamboo tableware processing method according to claim 1, wherein in S1, specifically comprising: immediately using a clamping member (4) to clamp a plurality of bamboo chips; or place defective replacement blocks between the plurality of bamboo chips and the clamping member, and clamp the plurality of bamboo chips and defective replacement blocks by means of clamping member.

5. The bamboo tableware processing method according to claim 1, wherein in S2, the position and angle of the milling cutter are selectively adjusted during the rotation of the milling cutter; or the adjusting the position of the milling cutter does not include the feeding direction of the plurality of bamboo chips.

6. The bamboo tableware processing method according to claim 1, wherein the bamboo chips are vertically and flatly arranged between the clamping members, and the plurality of bamboo chips are cut along a straight line by means of milling cutters on both sides, the plurality of bamboo chips are sequentially cut and processed at one time to form bamboo tableware-shaped bamboo chips.

7. The bamboo tableware processing method according to claim 1, wherein specifically comprising the following steps: S101: setting the milling cutter inside of the cover of the bamboo shavings collecting apparatus (6), and the cutting part of the milling cutter extends from the cover; S201: placing a plurality of bamboo chips between the clamping members (4) and clamping; or placing defective replacement blocks on both ends of the plurality of bamboo chips, and clamping the bamboo chips and the defective replacement blocks by means of the clamping members (4); S301: if the plurality of bamboo chips are not flat, performing a flattening step to ensure that the bamboo chips are flat; after flattening, the plurality of bamboo chips are further compressed; S401: controlling the clamping member (4) or the milling cutter (2) to move slowly, so that the plurality of bamboo chips are cut along a straight line through the milling cutter in sequence, when cutting, one side of the plurality of bamboo chips can be cut firstly, after cutting, then performing the cutting work on the other side; or simultaneously cutting the two sides of the plurality of bamboo chips to process at one time; S501: after cutting by the milling cutter, the plurality of bamboo chips are processed into bamboo tableware-shaped bamboo chips; after the clamping member is moved out of the working range of the milling cutter, controlling the clamping chips to loosen the bamboo chips.

8. A bamboo tableware processing apparatus, wherein comprising:
processing platform (1); milling cutter (2): the blade profile of the milling cutter (2) matches at least one side profile of the bamboo tableware;
motor (3): used to control the rotation of the milling cutter (2); clamping member (4): for clamping a plurality of bamboo chips at one time, at least one of the clamping member (4) and milling cutter (2) is movably arranged on the processing platform (1).

9. The bamboo tableware processing apparatus according to claim 8, wherein the clamping member (4) comprises two oppositely arranged clamping chips (41), at least one clamping chip is movably arranged.

10. The bamboo tableware processing apparatus according to claim 8, wherein the profile of the clamping chip (41) is the same as the profile of the corresponding bamboo tableware.

11. The bamboo tableware processing apparatus according to claim 8, wherein the processing platform (1) is arranged with a milling cutter adjusting apparatus (5), and the milling cutter (2) is arranged on the milling cutter adjusting apparatus (5); or the milling cutter adjusting apparatus comprises a first adjusting part and a second adjusting part, the first adjusting part is fixedly or movably connected to the processing platform, and the second adjusting part can be moved along the first part, and the second adjustment part and the milling cutter are fixedly connected, slidably connected, or rotationally connected.

12. The bamboo tableware processing apparatus according to claim 8, wherein the bamboo tableware is spoon, knife or fork; when the bamboo tableware is spoon, the profile of the milling cutter (2) matches one side profile of the spoon; the side profile of the spoon includes the straight line of the spoon handle, the circle arc of the connection between the spoon handle and the spoon head, and the half circular arc of the spoon head; the profile of the milling cutter (2) comprising: a straight line part corresponding to the length of the spoon handle, an arc part corresponding to the angle and radius of the connection, the half circular arc part corresponding to the angle and radius of the spoon head; when the bamboo tableware is knife, the profile of the milling cutter (2) matches one side profile of the knife; the knife includes a first side and a second side, and the first side of the knife comprises the straight line of the knife handle and the serrated arc of the knife head, the second side of the knife comprises the straight line of the knife back; there are two types of milling cutters (2) for processing the knife, the profile of the milling cutter (2) for processing the first side of the knife comprising: the knife handle straight line part corresponding to the straight line length of the knife handle, and the serrated arc part corresponding to the knife head; the profile of the milling cutter (2) for processing the second side of the knife comprising: the knife back straight line part corresponding to the straight line length of the knife back; when the bamboo tableware is fork, the profile of the milling cutter (2) matches one side profile of the fork; the side profile of the fork comprises the straight line of the handle, the arc of the connection between the handle and the head, the straight line of the head; the profile of the milling cutter (2) comprising: a straight line part corresponding to the straight line of the fork handle, an arc part corresponding to the arc of the connection, and a straight line part corresponding to the straight line of the fork head.

13. The bamboo tableware processing apparatus according to claim 8, wherein the milling cutter (2) is sleeved with a bamboo shavings collecting apparatus (6); the bamboo shavings collecting apparatus (6) comprises sequentially connected the knife cover (61), the pipeline (62), the fan and the collecting box, and the knife cover (61) is sleeved on the milling cutter (2): a cutting port (611) is arranged on one side of the knife cover (61).

14. The bamboo tableware processing apparatus according to claim 8, wherein at least one side of the clamping member (4) is arranged with a flattening plate (7) for flattening the bamboo chips, and the flattening plate (7) is arranged on the processing platform (1) by means of the actuator.

15. The bamboo tableware processing apparatus according to claim 8, wherein the milling cutters (2) have multiple groups, which are respectively located on the sides of the bamboo chips, and work at the same time to complete processing at one time.
